(19) United States
(12) Patent Application Publication
(10) Pub. No.: US 2010/0183418 A1
(43) Pub. Date: Jul. 22, 2010

(54) Pipe manipulating apparatus

(75) Inventors: Kris Henderson, Lafayette, LA (US); Lee M. Robichaux, Lafayette, LA (US); Joseph L. Hawkins, Maurice, LA (US); Lee J. Matherne, JR., Lafayette, LA (US)

Correspondence Address: JOHN D. JETER, P.O. BOX 846, SAINT MARTINVILLE, LA, 70582, US

(73) Assignee: PREMIERE, INC, NEW IBERIA, LA (US)

(21) Appl. No.: 12/321,308

(22) Filed: Jan. 16, 2009

(51) Int. Cl. B66F 11/00; F16H 55/17

(52) U.S. Cl. 414/745.1; 74/460; 74/731.1; 74/473.12

(57) ABSTRACT

An arbor, arranged for attachment to a drilling rigs overhead support and drilling fluid circuit, has a cross frame with axles that support telescoping link arms to carry a single stand elevator at their lower end. The link arms have provision, at their top end, to tilt about a horizontal axis. The link arms can extend an amount greater than their minimum length.

This invention relates to apparatus used to manipulate pipe being installed into, or removed from, wells. It may be used with top drives or with general purpose hoist equipment on drilling rigs.

### BACKGROUND

Pipe strings used in wells are usually threadedly connected assemblies. They are usually joined one stand at a time. A stand may consist of one or more pipe sections. The stands consisting of more than one section are usually pre-torqued at the pre-assembled connections.

Pipe installation rates favor the big rigs, largely because the big rigs have the vertical space needed to handle the larger number of pipe sections per stand. The vertical space is always limited and the length of the vertical pipe manipulating apparatus is limited. Excesses length of manipulation gear may reduce the number of pipe sections per stand.

In recent years, link arms that carry a single stand elevator to engage the on-coming pipe stand while the main hoist is lowering the pipe string into the well has added length to the manipulation gear. It is desirable to use telescoping link arms that can draw the new stand into the pipe gripping arrangement. That creates a problem.

A conventional telescoping link arm has a maximum length somewhat less than twice the minimum length. It is the minimum length that conflicts with the limited vertical space matter. There is a need for a link arm that can extend more than twice its minimum length. This invention addresses that matter.

### SUMMARY OF THE DISCLOSURE

A body that can be attached to a top drive or to rig swivel arrangements has two link arms attached that can carry a single stand elevator. The link arms can be tilted to bring the single stand elevator into engagement with a nearby stand. The link arms telescope to allow them to lift a new stand into a pipe gripping arrangement. The novel link arm telescopes in both axial directions from a central body. It can extend to more than twice its shortest length. The apparatus can support most known pipe gripping arrangements.

These and other objects, advantages, and features of this invention will be apparent to those skilled in the art from a consideration of this specification, including the attached claims and appended drawings.

### BRIEF DESCRIPTION OF DRAWINGS

The exemplary drawings illustrate apparatus capable of practicing the points of novelty claimed. They embody the preferred configuration in a general sense. They should not be construed in a limiting sense.

FIG. 1 is a side view of the apparatus in the short configuration.

FIG. 2 is a view of the back of the apparatus in the short configuration.

FIG. 3 is a top view of the apparatus.

FIG. 3A is a partial section, rather enlarged, of a fragment of the apparatus with the linear motors replaced by partial-turn rotary motors.

FIG. 4 is a view similar to FIG. 1 but in the extended configuration.

FIG. 5 is a view similar to FIG. 2 but in the extended configuration.

FIG. 6 is a side view, somewhat enlarged, of a shortened link arm shown as part of FIG. 1.

FIG. 7 is similar to FIG. 6 but in the extended configuration shown in FIG. 4.

FIG. 8 is a section, further enlarged, taken along line 8-8 of FIG. 7.

FIG. 9 is a section, further enlarged, taken along line 9-9 of FIG. 7.

FIG. 10 is, in effect, the apparatus of FIG.1 in the tilted configuration.

FIG. 11 is, in effect, the apparatus of FIG. 4 in the tilted configuration.

FIG. 12 is a top view of an alternate form of a swing arm laid horizontally.

FIG. 13 is a side view of the swing arm of FIG. 12.

FIG. 14 is a sectional view taken along line 14-14.

FIG. 15 is the swing arm of FIG. 13, extended, and partly cut away.

FIG. 16 is the same as FIG. 15, but in a contracted position.

### DETAILED DESCRIPTION OF DRAWINGS

In the formal drawings, some details that do not bear upon points of novelty, and are well within the scope of those skilled in the art, are omitted in the interest of descriptive clarity. Such omissions may include weld lines, some threaded fasteners, pins, seal details, and the like.

In normal use the apparatus will be fitted with a pipe engagement device of the users choice. The apparatus, in turn, will be carried by a top drive or a traveling block or swivel. Such arrangements are well known by those skilled in the related art and none are shown in the present drawings.

Some hydraulic linear motors are preferred in the design and some source of fluid power is essential in their usual operation. Such sources are usually present on the drilling rig and their familiarity is likely preferred by operating personnel. The usual related power circuitry is not shown. Electrically powered linear motors are available to replace the preferred hydraulic cylinders. Such options are well known and none are presented in the present drawings.

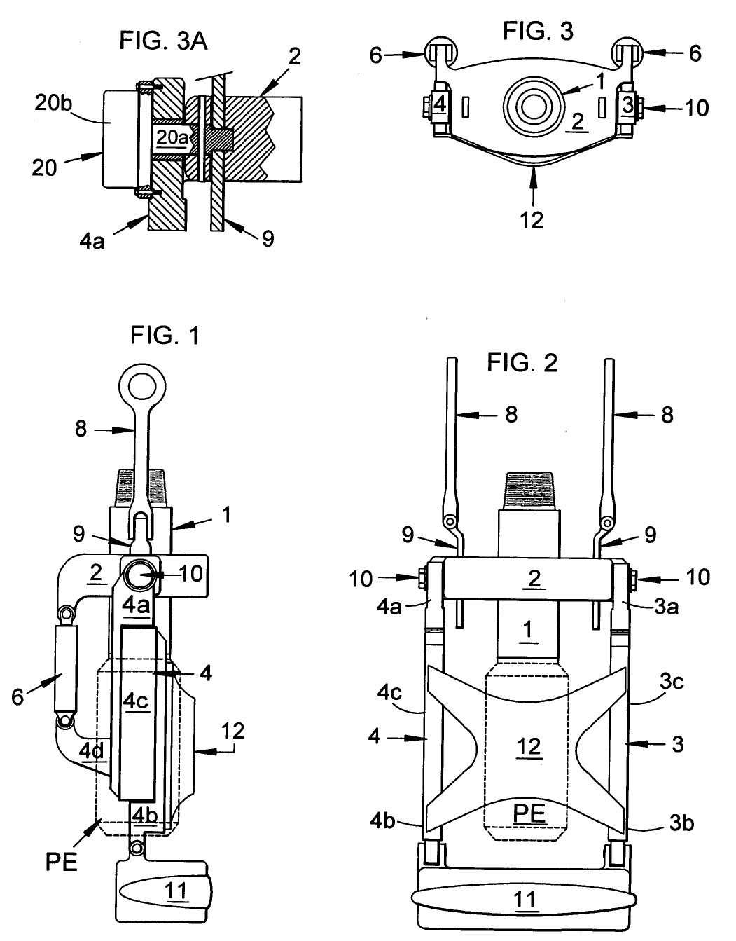

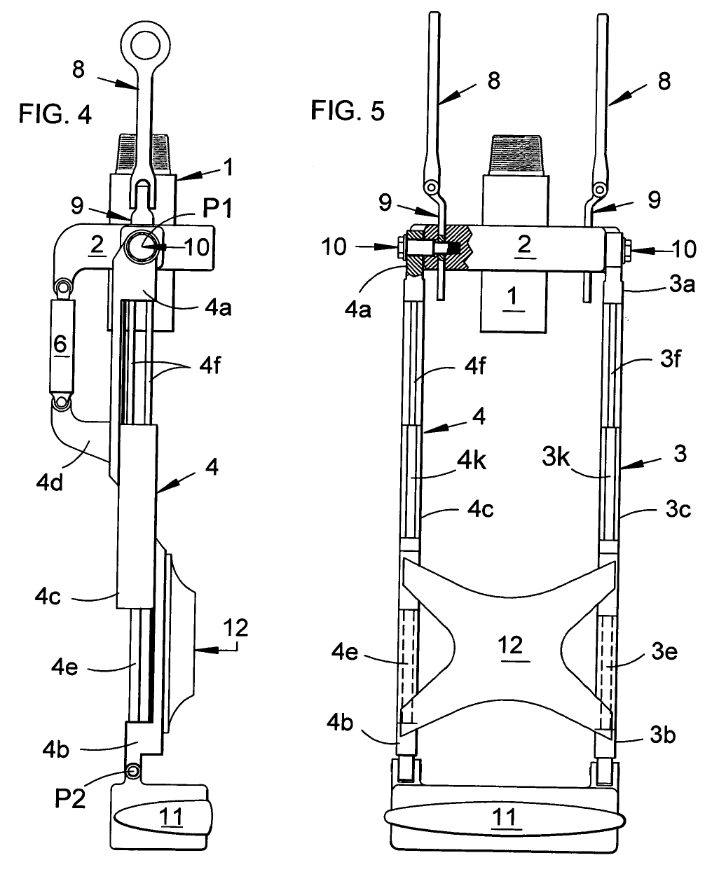

FIG. 1 shows main arbor 1 carrying the cross frame 2 which has axles 10 projecting radially to pivotably support link arms 3 and 4. The link arms carry single stand elevator 11. The link arms can pivot about axles 10 powered and controlled by linear motor 6 acting on supports 4d and the cross frame 2. Link arm 4 has telescoping ends 4a and 4b extendable from mid-section 4c, more clearly shown by FIG. 4. The gusset plate 12 adds stability to the link arms.

Bails 8 support the apparatus by way of links 9 secured to the cross frame 2. The pipe engagement device PE is shown carried by main arbor 1. The device PE is not part of the present invention.

FIG. 2 shows the back of the apparatus. Link arm 3 is identical to link arm 4. Construction details will be limited to link arm 3. Ends 3a and 3b ride in T-slots in mid-section 3c, shown more clearly in FIGS. 7-9.

FIG. 3, a top view, shows the relationship between linear motors 6 and axles 10.

FIG. 3A shows an alternate motor control to tilt the link arms. This view is best understood as an alternate for the cut-away portion of FIG. 5. The motor 20 with shaft 20a does not rotate, the motor body 20b rotates. The body 20b is mounted on the swing arm 4a and causes the link arm to rotate.

FIG. 4 is identical to FIG. 1, but with link arms extended. The mid-section 4c has three cylinder bores with cylinder rods 4f and 4e exposed. The rods 4f are paired and arranged to deliver a true thrust vector between pivot points, P1 and P2, at opposite ends of the link arm. Cylinder bores in section 4c (note FIGS. 7-9) with associated pistons and rods comprise simple linear motors.

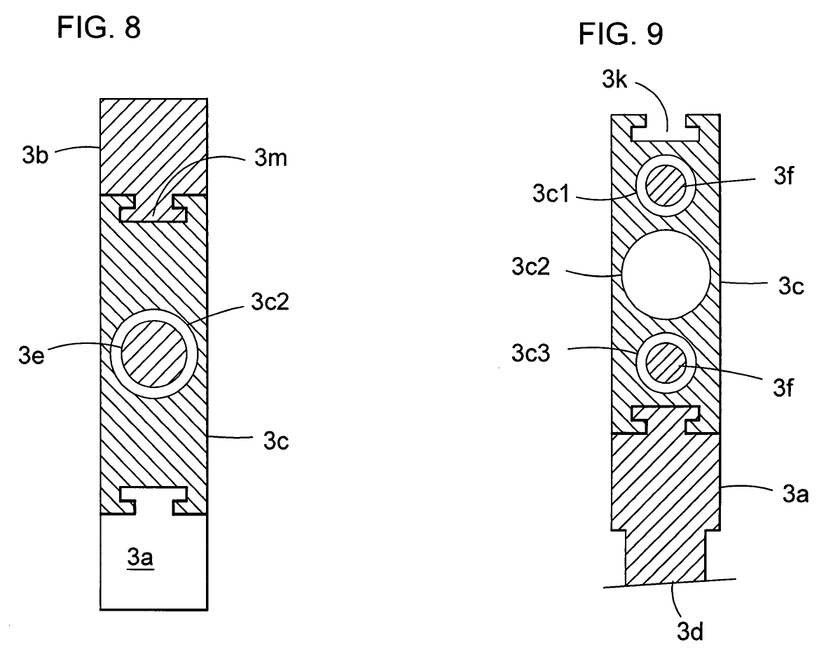

FIG. 5 is identical to FIG. 2, but with link arms extended. T-slot 3k is the way that mid-section 3c retains control of end 3b. A similar arrangement on the far side of 3c similarly engages end 3a. FIGS. 8-9 show the slide controls in more detail.

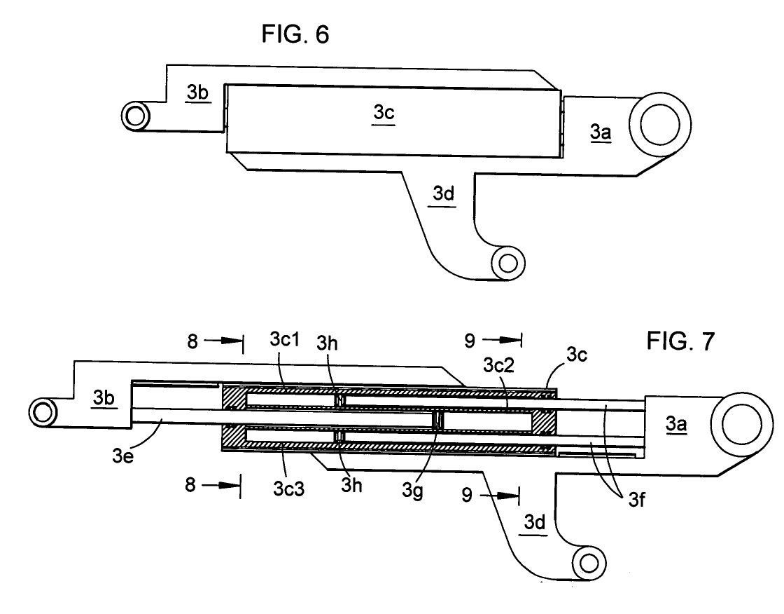

FIG. 6 shows a link arm with length minimized. If the Partial-turn motor shown by FIG. 3 is used, the projection 3d is not needed and will be omitted.

FIG. 7 shows the link arm of FIG. 6 partially extended. Bores 3c1 and 3c3 receive pistons 3h and rods 3f to provide a thrust vector extending through both P1 and P2. The piston 3g, on rod 3e, in bore 3c2 has the same piston area as pistons 3h combined.

FIG. 8 is a rather enlarged section taken along line 8-8 of FIG. 7. T-slot runner 3m, preferably, extends the full length mid-section 3d.

FIG. 9 shows a section that does not cut link arm end 3b. T-slot 3k, preferably, runs the full length of mid-section 3c. Link arm end 3a has a T-slot rider in a similar slot on the opposite side of mid-section 3c.

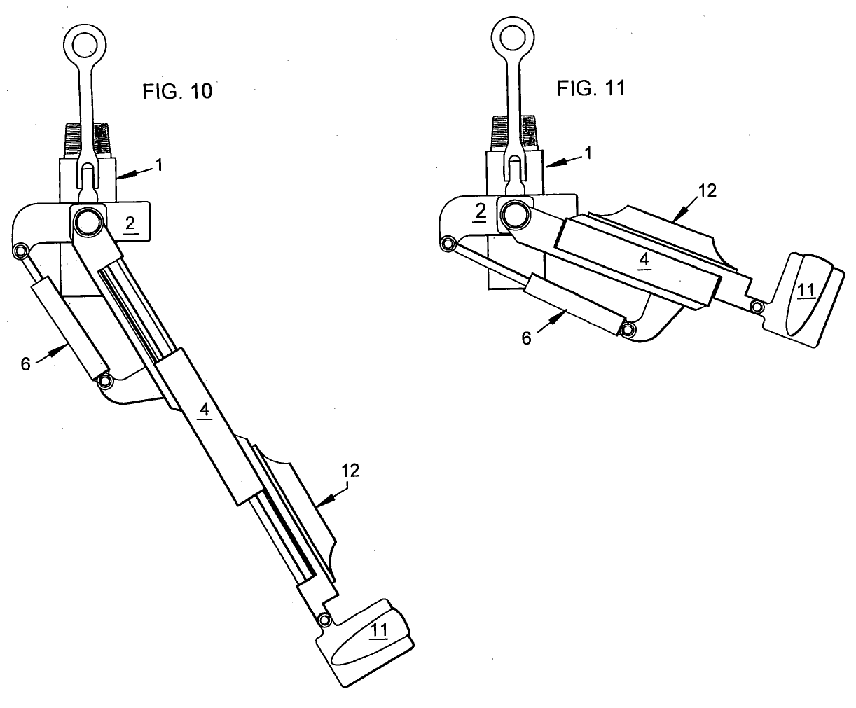

FIGS. 10-11 show the link arm tilted by linear motor 6 in the extended and contracted configurations respectively.

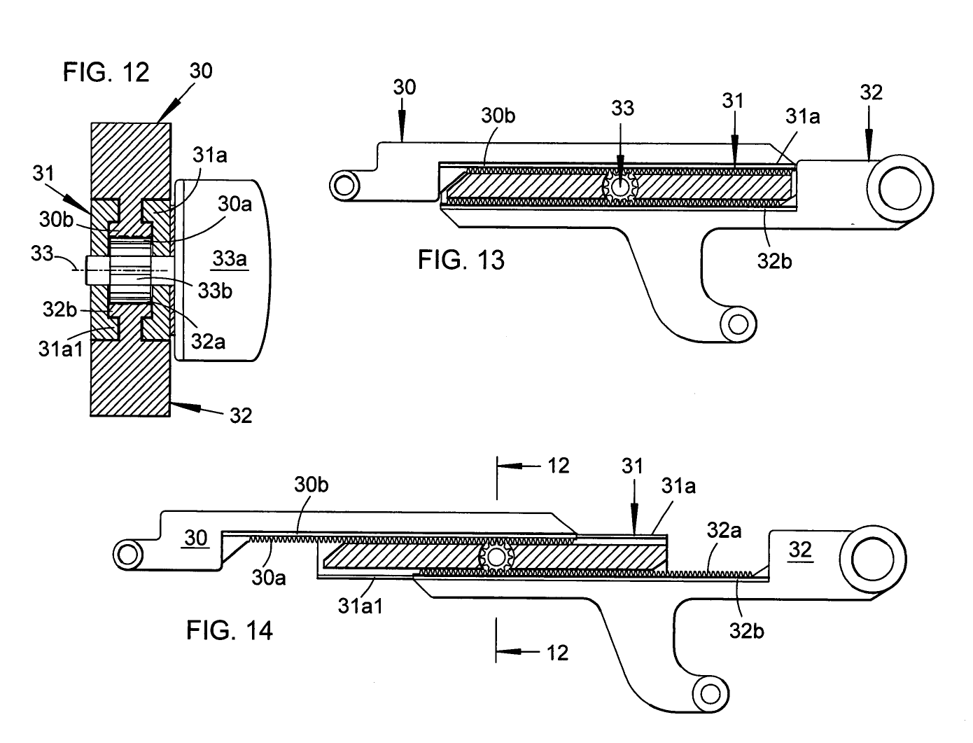

FIGS. 12-16 represent a rotary motor, gear, and rack form of linear motor driven swing arm laid horizontally.

FIG. 12 is a section through the rotational axis 33 of rotary motor 33a. The telescoping elements are captioned 30, 31, and 32. Motor 33a and spur gear 33b rotate about axis 33. End 30 has tongue 30b carrying rack gear 30a along rails 31a1. End 32 has tongue 32b carrying gear rack 32a. End 32 is carried along rails 31a. Rotation of motor 33a moves ends 30 and 32 in opposite directions.

Motor 33a is, preferably, a stepping motor and gearbox combination with a power released brake. Such motors are commercially available. When combined with appropriate power, control, and signal circuitry the arrangement can indicate a present telescopic position and automatically go to an operator defined control position and set the brake at that position.

FIG. 13 shows the link arm in a contracted position and FIG. 14 shows it in an extended position.

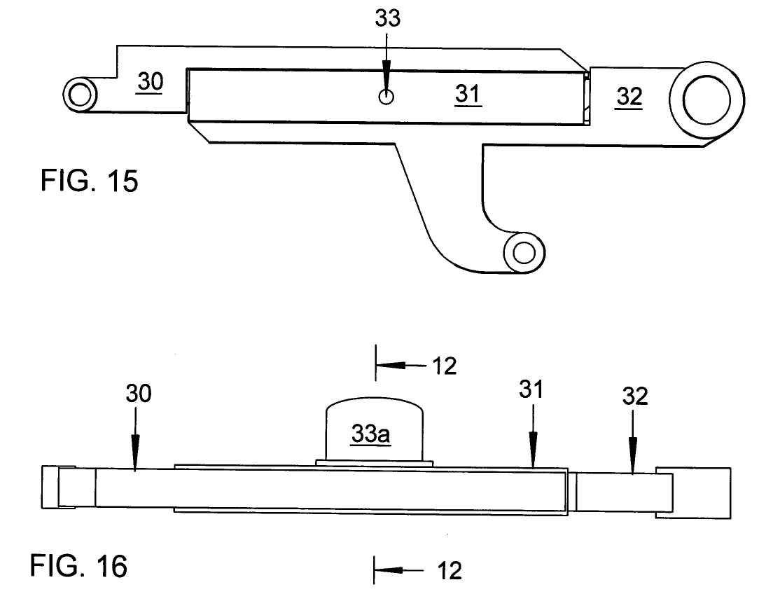

FIG. 15 shows the link arm with no cut-aways. In the closed position shown, the link arm mechanism is well protected.

FIG. 16 is seen from above FIG. 15. Motor 33a can be, mounted on either side of the component 31.

From the foregoing, it will be seen that this invention is one well adapted to attain all of the ends and objects hereinabove set forth, together with other advantages which are obvious and which are inherent to the apparatus.

It will be understood that certain features and sub-combinations are of utility and may be employed without reference to other features and sub-combinations. This is contemplated by and is within the scope of the claims.

As many possible embodiments may be made of the apparatus of this invention without departing from the scope thereof, it is to be understood that all matter herein set forth or shown in the accompanying drawings is to be interpreted as illustrative and not in a limiting sense.

The invention having been described, we claim:

1. A pipe manipulating apparatus for use in the production of drilled wells, adapted to operate in conjunction with the pipe string supporting gear of the rig and adaptable to handle pipe by supporting pipe gripping devices, the apparatus comprising:
a) a main arbor arranged for attachment to upwardly extending pipe string support means of a drilling rig;
b) a cross frame structure secured to said arbor, with provisions to support pipe string carrying apparatus extending downwardly; and having opposed link arm support axles extending from opposite sides;
c) said link arms, one on each side of said cross frame structure, arranged to pivot at an upper end about said axles and support a pipe stand elevator pivotably attached on a lower end, said link arms comprising a mid-section with said ends extending telescopically in opposite directions therefrom;
d) a tilt motor, attached to said cross frame and to each said link arm to pivot said link arm about said axle in response to power supplied from an external source to said motor;
e) an extension control motor intrinsic to each said link arm to execute and control telescoping movement of said ends in response to power signals supplied from an external source;
f) said pipe stand elevator; and
g) power delivery circuitry arranged to conduct power from said external source to and into the apparatus.

2. The apparatus according to claim 1 wherein said tilt motor is a fluid power cylinder.

3. The apparatus according to claim 1 wherein said tilt motor is a partial turn fluid powered motor.

4. The apparatus according to claim 1 wherein said extension control motor is a fluid power cylinder.

5. The apparatus according to claim 1 wherein said extension control motor is electric powered.

6. The apparatus according to claim 5 wherein said extension control motor is a stepping motor.

7. The apparatus according to claim 5 wherein said extension control motor is housed with a gearbox to reduce the speed of said spur gear and a brake to lock said spur gear when said motor is not empowered to move said ends.

8. A pipe manipulating apparatus for use in the production of drilled wells, adapted to operate in conjunction with the pipe string supporting gear of a drilling rig and adaptable to handle pipe by supporting pipe gripping devices, the apparatus comprising:
a) a main arbor arranged for attachment to upwardly extending pipe string support means of a drilling rig;
b) a cross frame structure secured to said arbor, with provisions to support pipe string carrying apparatus extending downwardly; and having opposed link arm support axles extending from opposite sides;
c) said link arms, one on each side of said cross frame structure, each arranged to pivot at an upper end about one of said axles and support a pipe stand elevator pivotably attached on a lower end, said link arms comprising a mid-section with said ends extending telescopically in opposite directions therefrom;
d) a tilt motor, attached to said cross frame and to each said link arm to pivot said link arm about said axle in response to power supplied from an external source to said motor;
e) an extension control motor intrinsic to each said link arm to execute and control telescoping movement of said ends in response to power signals supplied from an external source;
f) said pipe stand elevator; and
g) power delivery circuitry arranged to conduct power from said external source to and into the apparatus.

9. The apparatus according to claim 8 wherein said tilt motor is a fluid power cylinder.

10. The apparatus according to claim 8 wherein said tilt motor is a partial turn fluid powered motor.

11. The apparatus according to claim 8 wherein said extension control motor is a fluid power cylinder.

12. The apparatus according to claim 8 wherein said extension control motor is electric powered.

13. The apparatus according to claim 12 wherein said extension control motor is a stepping motor.

14. The apparatus according to claim 12 wherein said extension control motor is housed with a gearbox to reduce the speed of said spur gear and a brake to lock said spur gear when said motor is not empowered to move said ends.
